(19) United States
(12) Patent Application Publication
(10) Pub. No.: US 2009/0006085 A1
(43) Pub. Date: Jan. 1, 2009

(54) AUTOMATED CALL CLASSIFICATION AND PRIORITIZATION

(75) Inventors: Eric J. Horvitz, Kirkland, WA (US); Ashish Kapoor, Cambridge, MA (US); Sumit Basu, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/770,921

(22) Filed: Jun. 29, 2007

(51) Int. Cl. G10L 19/12

(52) U.S. Cl. 704/223; 379/88.01

(57) ABSTRACT

An automated voice message or caller prioritization system that extracts words, prosody, and/or metadata from a voice input. The data extracted is classified with a statistical classifier into groups of interest. These groups could indicate the likelihood that a call is urgent versus nonurgent, from someone the user knows well versus someone that the user only knows casually or not at all, from someone using a mobile phone versus a landline, or a business call versus a personal calls. The system then can determine an action based on results of the groups, including the display of likely category labels on the message. Call handling and display actions can be defined by user preferences.

### TECHNICAL FIELD

The subject specification relates generally to computerized classification of input data and in particular to classifying telephone calls and determining an action based on the classification.

### BACKGROUND

The use of a communication system that records messages has become an integral part of every day life among professionals and non-professionals. Specifically, the use of voicemail, e-mail and text messaging has dramatically increased. Such messaging methods have become a cost efficient way of communicating with individuals with busy schedules. For example, an individual with meetings all day long can easily check his messages between meetings for updates on important matters. The use of voicemail and e-mail messaging, especially, has replaced the need for secretaries and provided accuracy in receiving messages.

Traditionally, answering machines record voicemail messages and play them back in a sequential manner. To determine if a message is of interest, an individual would have to listen to each message sequentially and make that determination. This can be very time consuming for a busy individual. With numerous amounts of messages, finding messages of interest can be a tedious task, especially under time constraints. E-mails and text messages are easier than voicemail messages to quickly scan through because they contain contact information and a subject line which can indicate who the individual is and the urgency of the message. Voicemail messages are more difficult to scan through because an individual must listen to each message to determine if the message is of interest. Thus, there exists an unmet need in the art for techniques for effectively categorizing and providing expedited access to voicemail messages.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

In accordance with one aspect, a system is provided that classifies voice files. The voice files can be either recorded messages or real-time telephone calls. The system can analyze features of the voice files by using multiple classes of evidential features, for example, key words identified via automatic speech recognition, prosodic features including such observations as syallabic rate and pause structure, and metadata such as time of day, call duration, and caller id (if available). These features can then be extracted and used in building statistical classifiers that can classify real-time or voice recordings as business callers, personal callers, unsolicited callers (for example, telemarketers), and such subtle classes as callers who are very close versus not close to a user, callers that are mobile versus non-mobile, whether a voice call is urgent or nonurgent, or the degree of urgency of the call. Degrees of urgency or classes of urgency can be used in voice prioritization.

Such classification and prioritization systems can employ one or more machine learning methodologies. The machine learning device can employ, for example, the Gaussian Process (GP) Classification to learn speech pattern data, construct trained models from the learned data, and then draw inferences from the trained models. Furthermore, a Bayesian network may be incorporated to interpret the classification of voice inputs. Other algorithms, besides the Gaussian Process and the Bayesian network, may be used to extract and classify key features.

With regard to the use of machine learning to prioritize voice messages, a determination of a level of urgency can be made from multiple classes of evidence extracted from messages. This categorization can particularly assist in sorting through voicemail messages for messages of interest. In one example of the claimed subject matter, if a real time call is being analyzed, the system can determine if the call should proceed to the user or if the call should instead be directed to voicemail messaging based on the identity of the caller and the level of urgency indicated by the speech patterns of the caller.

In another example of the claimed subject matter, if a voicemail message is being analyzed, the system can display information based on a classification of speech patterns present in the message onto a graphical user interface. For example, an individual in a meeting can see who is calling and the level of urgency from a computing system. Upon seeing the information on a graphical user interface, the individual can decide if it is appropriate to interrupt the meeting and return the call or decide when an appropriate time to return the call would be.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a high level block diagram of a recommendation system in accordance with an aspect of the subject specification.

FIG. 2 illustrates a block diagram of a system of analyzing and classifying a voice file in accordance with an aspect of the subject specification.

FIG. 3 illustrates an exemplary system for classifying voice files in accordance with an aspect of the subject specification.

FIG. 4 illustrates an example system that can utilize machine learning to classify voice files in accordance with an aspect of the subject specification.

FIG. 5 illustrates an example system that can optimize system variables of a distributed system in accord with aspects of the subject disclosure.

FIG. 6 illustrates an example system that can optimize system variables of a call prioritization system in accord with additional aspects of the claimed subject matter.

FIG. 7 illustrates example value of information (VOI) data for a decision-theoretic framework in active learning in accord with aspects of the subject disclosure.

FIG. 8 illustrates an exemplary methodology for classifying voice files in accordance with an aspect of the claimed subject matter.

FIG. 9 illustrates an example methodology for analyzing and classifying voice files in accordance with an aspect of the claimed subject matter.

FIG. 10 illustrates an example methodology for analyzing and classifying voice files and determining an action in accordance with an aspect of the claimed subject matter.

FIG. 11 illustrates an example of automatic call classification and prioritization displayed on a graphical user interface.

FIG. 12 illustrates an example of key features extracted from a voice input.

FIG. 13 illustrates an example of key features extracted from a personal, non-urgent call.

FIG. 14 illustrates an example of key features extracted from an impersonal, urgent call.

FIG. 15 illustrates a block diagram of a computer on which the disclosed architecture can be executed.

FIG. 16 illustrates a schematic block diagram of an example computing environment in accordance with the subject specification.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

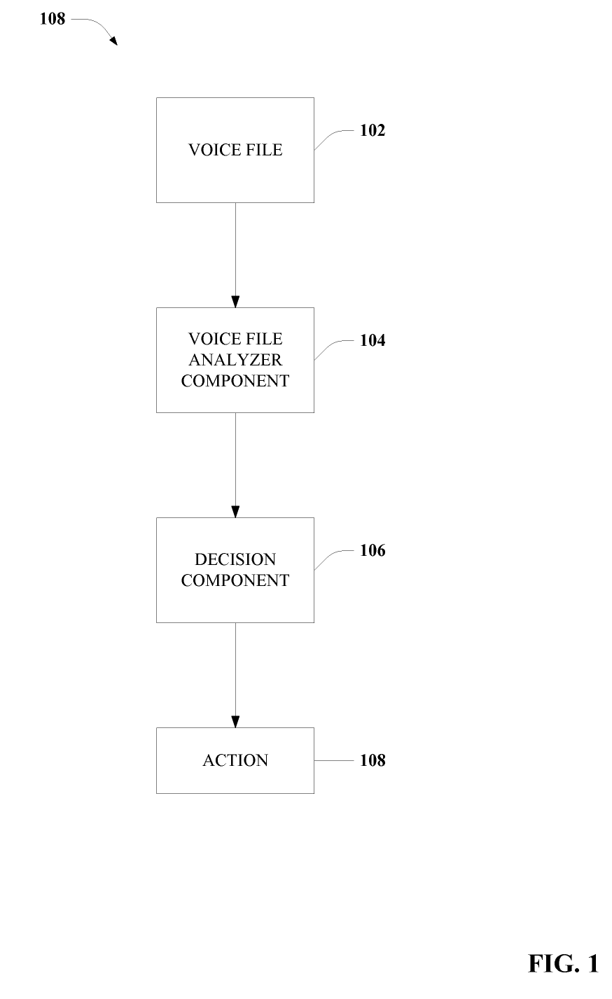

Referring now to the drawings, FIG. 1 illustrates a recommendation system 100 in accordance with an aspect of the subject specification. The speech patterns of a voice file 102 can be classified to facilitate message retrieval. A voice file 102 can be analyzed by a voice file analyzer component 104. In one example, the voice file analyzer component 104 can examine speech patterns of a voice file 102 and extract speech pattern data relevant to classifying the voice file 102. In another example, the speech pattern data can then be scrutinized by a decision component 106, which can determine an action based on the speech patterns.

By way of specific, non-limiting example, a voice file 102 can be a recorded voice message or a real time call. Alternatively, the voice file 102 can be an electronic device. For example, a user can request updates on the news. A stream of news broadcasts can be assessed by the voice file analyzer component 104. If the speech patterns (e.g. key words) in the news broadcast indicate urgency, a user can be notified. Electronic devices used may include, but are not limited to, radio, television and the Internet.

In building classifiers, methods for parsing evidence of different kinds from voice messages are needed both to construct training sets, which provide the basis for building classifiers—and also for analyzing the properties of incoming messages that are targets of classification.

In accordance with one aspect, data from speech patterns of a voice file 102 extracted by voice file analyzer component 104 can include, for example, metadata, prosodic features, and/or key words. In building training sets for classifiers words in messages may be parsed from the messages by automated speech recognition systems, employing continuous or word-spotting based speech recognition methodologies. The data from the voice file 102 can additionally be defined or appended by user preference. For example, a user may define the word “hospital” as a key word. Other examples of user defined speech patterns may include the identity of the caller, the type of phone the caller is calling from, the syallabic rate, patterns of pitch in the voice file 102, and/or the patterns of pauses, e.g., different statistics of the durations of the lengths of pauses between words in the voice file 102. In accordance with another aspect, the system 100 can identify the voice file 102. Once a voice file 102 is identified, an establishment of a degree of urgency can be ascertained. A user can navigate through messages to determine the priority of the calls according the level of urgency of the voice file 102.

In another example, the speech patterns extracted from the voice file 102 can assist a decision component 106 to implement an action 108. An action 108 can be user defined. In one aspect of the claimed subject matter, an action 108 for a recorded voice message can transmit data corresponding to speech patterns to a graphical user interface. A user can scan the data on the graphical user interface and determine which messages are of interest. In one example, data communicated to the graphical user interface can be user defined. For example, a user may ask to only send data to the graphical user interface for messages deemed urgent.

A graphical user interface can be implemented in conjunction with an e-mailing system. The user can check e-mails and voice message priority simultaneously. The graphical user interface can also be retrieved from electronic devices other than a computer. For example, voice file data can be transferred to a cell phone, a palm pilot, and/or another suitable electronic device.

In another aspect of the claimed subject matter, a speech pattern of a live caller can be evaluated. For example, a live caller can be put on hold. Analysis of speech patterns can reveal identity of caller, a telephone number related to the call, urgency of the call and/or if the call is personal or business. Based on a speech pattern analysis and a user preference, a decision component 106 can forward a call to caller or to voice messaging.

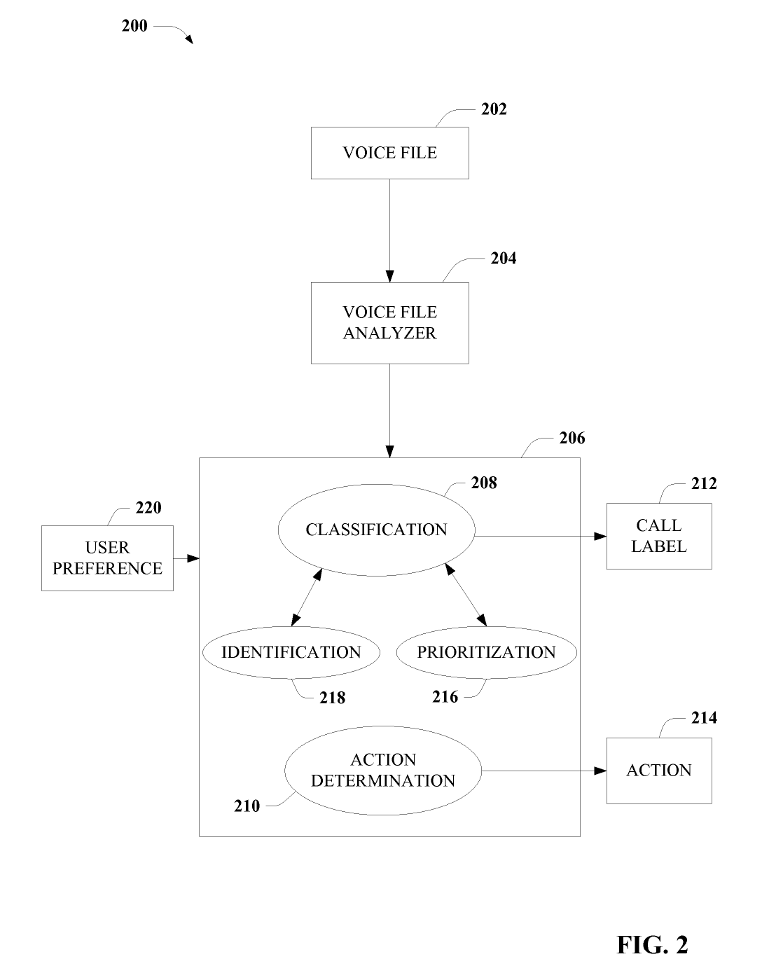

FIG. 2 illustrates a system 200 of analyzing and classifying a voice file 202. In one example, the system 200 can incorporate a decision component 206 having a classification component 208 and an action determination component 210. A voice file 202 can be examined by a voice file analyzer 204, where speech patterns can be ascertained. The decision component 206 can subsequently implement an action based on the speech patterns extracted.

In an aspect of the claimed subject matter, classification component 208 can group speech patterns obtained from a voice analyzer component 204. For example, speech patterns that contain a pitch indicating urgency can be classified as urgent. Examples of classification groups include identity of a caller, distance from the point of origination of a call, callers the user knows or does not know, bulk calls, call urgency, and/or personal or business calls. A call label component 212 can label a voice file 202 based on a classification. For instance, an urgent call can be labeled as urgent. This feature can assist a user in determining which call messages are of interest by specifically looking at the group in which the call messages are labeled. In one example, each group is predefined by user preference 220.

In accordance with one aspect, a classification component 208 associates with an identification component 218 and a prioritization component 216. The identification component 218 can determine the identity of a caller by unique speech patterns of the caller. Additionally and/or alternatively, the prioritization component 216 can determine the level of urgency indicated by speech patterns of the caller.

In one example, a classification of speech patterns made by the classification component 208 can be used by an action determination component 210 to indicate an action 214 to be taken. In one aspect of the claimed subject matter, once a recorded message is classified by the classification component 208 and assigned a call label 212, the action determination component 210 can send a data message to a graphical user interface. In one example of the claimed subject matter, the graphical user interface can display caller identification and a call label 212 associated with the call. A user can check the graphical user interface from an electronic device. Such electronic devices can include the Internet (e.g. e-mail or webpage), cell phones and/or palm pilots.

In another aspect of the claimed subject matter, a real time voice file can be categorized by the classification component 208 and assigned a call label 212. Based on the classification by classification component 208, action determination component 210 can convey the call to a user or to voicemail messaging. This action can also be defined by user preference 216. In another example, a voice file label can be sent to the user through an electronic device, at which time a user can manually answer the corresponding call or forward the call to voice mail messaging.

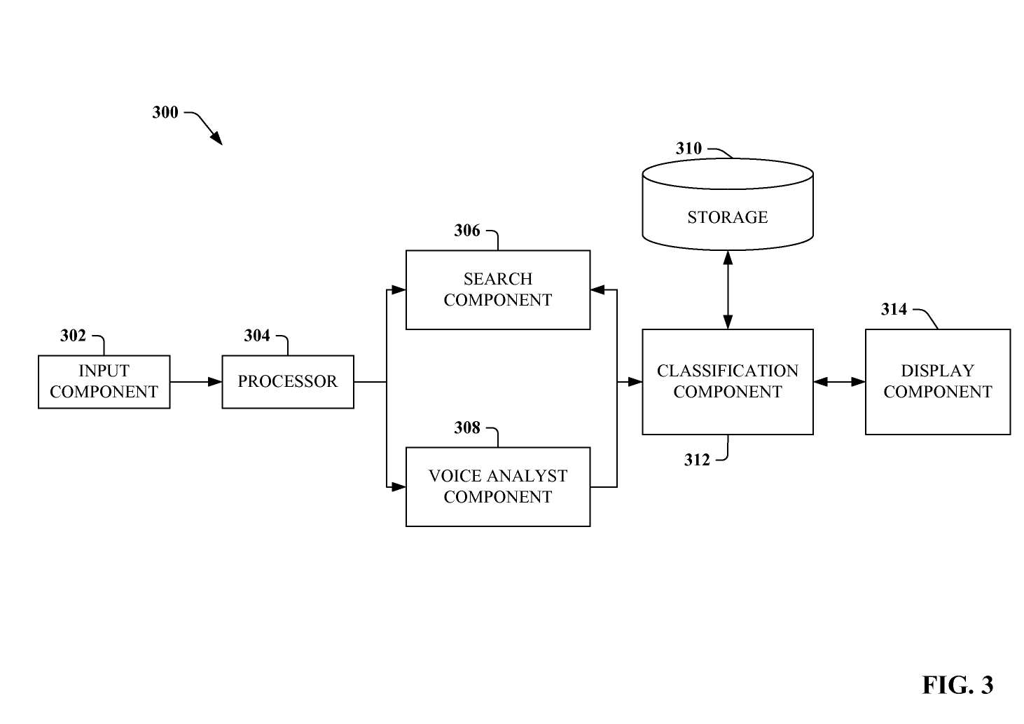

FIG. 3 illustrates an exemplary system 300 for classifying voice files in accordance with an aspect of the subject specification. A voice file can be streamed to an input component 302. By way of non-limiting example, the voice file can be streamed through recorded messages, real time voice files, and/or electronic devices (e.g., news and radio broadcasts). In one example, the input component 302 can be implemented as a conventional telephone, which can be associated with an electronic device enabling a connection to a processor 304. In another example, the input component 302 can be a digital answering machine associated with an electronic device and/or a processor 304. As another alternative, input component 302 can be an electronic device such as a television, radio, and/or computer system.

The processor 304 can convert information received by the input component 302 into computer readable data to be used in conjunction with a voice analyst component 308 and a search component 306. The processor 304 can be a conventional central unit that coordinates operation of the input component 302. The processor 304 can be any of various commercially available processors.

In one example, the search component 306 can determine if a voice file is a unique voice file that has not been classified. Training of the system 300 can be implemented to actively teach the system 300 to recognize frequent callers. During system training, the system 300 can identify unique voice files to facilitate future recognition of speech patterns. In another example, the voice analyst component 308 can scrutinize a voice file to provide key features used to classify a call. Additionally and/or alternatively, the voice analyst component 308 can transmit information relating to operation of a search component 306 and a classification component 312.

A classification component 312 can additionally be employed by system 300 to classify speech patterns received from voice analyst component 308. In another aspect of the claimed subject matter, the classification component 312 can associate with a machine learning device in order to enable the search component 306 to send information about unique voice files to the classification component 312. In addition, a machine learning device can be associated with classification component 312 to classify new voice files and train the system 300 to distinguish speech patterns of different callers. The classification component 312 can then label each call according to speech patterns. Further, the classification component can store calls and corresponding labels in a storage component 310. The classification component can also refer to a storage component 310 to classify and label voice files that have been identified by the training system 300

In accordance with one aspect, system 300 can further include a display 314 to allow a user to view information that relates to a voice file. Voice file labels can be displayed for ease of navigating through several voice messages. For example, a user can utilize the display 314 to retrieve messages of interest from the storage component 310.

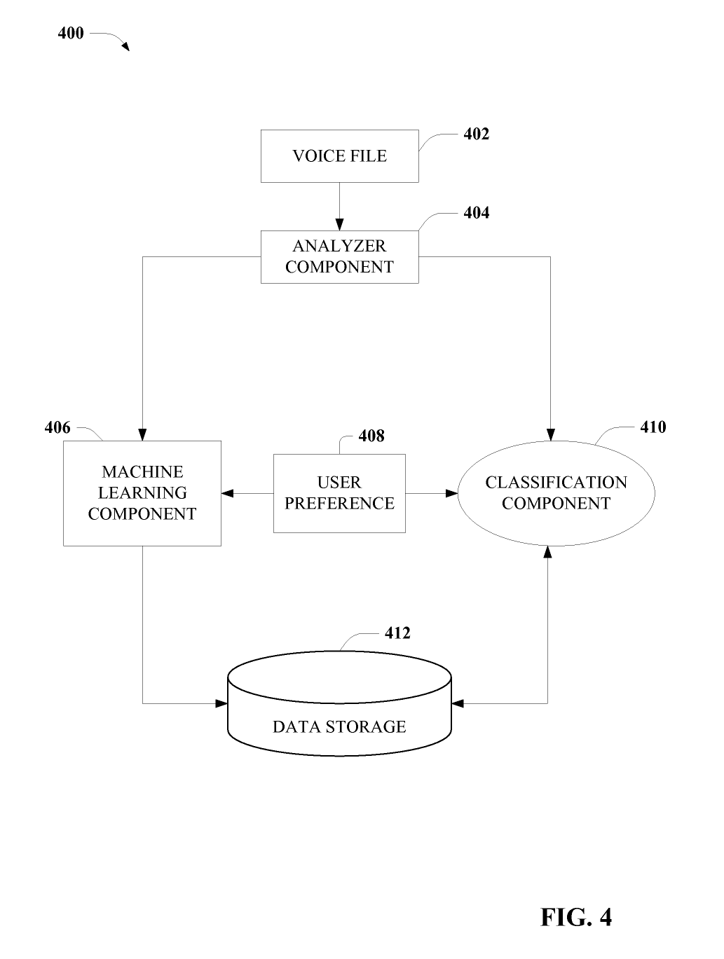

FIG. 4 illustrates an exemplary system 400 that can utilize machine learning to classify voice files 402. In one example, a voice file 402 is analyzed by an analyzer component 404. The analyzer component 404 can scrutinize the voice file 402 for speech patterns. According to one aspect of the claimed subject matter, the voice file prioritization system 400 can recognize speech patterns of frequent callers. For example, system 400 can differentiate speech patterns of frequent callers to classify a voice file 402 as a personal call or a business call.

The system 400 can further use a machine learning component 406 to train the system 400 to recognize certain speech patterns of the voice files. In one example, the machine learning component 406 can receive speech pattern data from the analyzer component 404. Machine learning component 406 can also facilitate training of the system. During system training, machine learning component 406 can relate speech patterns to particular voice files. For example, the system 400 can identify a caller by name according to the speech pattern of the caller.

Once speech pattern data is received by the machine learning component 406, a user can file the name of a particular caller. The speech pattern data can be labeled and stored in data storage 412. In addition, other information can be entered relating to the speech pattern data. For example, a user can specify whether a voice file 402 originated from a personal contact or a business contact. The machine learning component 406 can create a trained model to recognize speech patterns for implementation by a classification component 410.

In another embodiment of claimed subject matter, the machine learning component 406 can evaluate and classify speech patterns using algorithms that determine whether changes in a speech pattern indicate urgency by changes in pitch and pauses. By the input of many speech patterns representative of a particular class, the machine learning component 406 can develop a well developed trained model that increases the accuracy of future classifications.

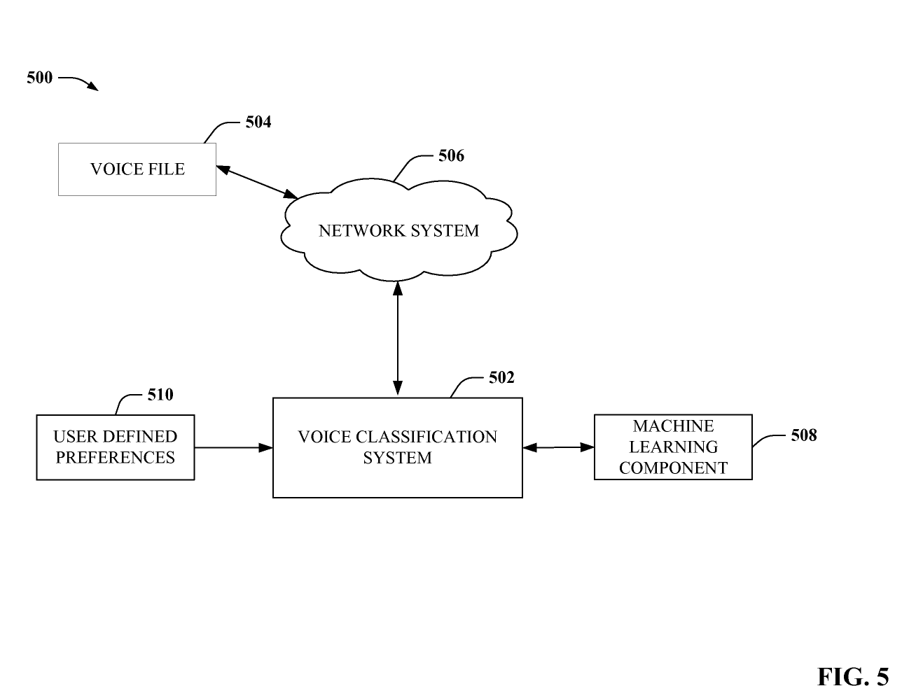

FIG. 5 illustrates an example system 500 that can employ artificial intelligence to automate the classification of a voice file 504 in accord with aspects of the subject disclosure. In one example, a voice file prioritization system 502 can receive and process voice files 504 by strategic agents among devices in a network system 506. By way of specific, non-limiting example, such processing can include classifying and grouping voice files 504 into user-defined groups.

Additionally, voice file prioritization system 500 can incorporate a machine learning (ML) component 508. In one example, ML component 508 can store and reference information related to speech patterns of particular voice files 504 and assist in recognizing and classifying future frequent voice files 504. As an example, user defined preferences 510 can indicate which speech patterns need to be classified and what groups should be labeled. For example, key words analyzed by the voice classification system 500 can be defined by the user as any words that may be of interest while navigating through voice mail messages. ML component 508 can reference user defined preferences 510, and the identity of the caller, for instance, associated with a voice file 504 and make a strategic determination regarding the classification of the voice file 504. Such determination can facilitate, for instance, navigation through voice mails by the user in search of messages of interest. In such a manner, system 500 can anticipate the identity of the caller and the urgency of the message, call, or news broadcast.

To make strategic determinations about the classification and grouping of the voice file by a user, or similar determination, the ML component 508 can utilize a set of models (e.g., agent preference model, voice file history model, speech pattern model, etc.) in connection with determining or inferring which classification is assigned a given voice file by a given agent. The models can be based on a plurality of information (e.g., user specified preferences 510, voice files 504 as a function of frequency of inputs, specific changes in speech patterns related to a specific voice file, etc . . . ). Optimization routines, or Active Learning, associated with ML component 508 can harness a model that is trained from previously collected data, a model that is based on a prior model that that is updated with new data, via model mixture or data mixing methodology, or simply one that is trained with seed data, and thereafter tuned in real-time by training with actual field data during voice inputs or data compiled from processor relating to the speech patterns.

In addition, ML component 508 can employ learning and reasoning techniques in connection with making determinations or inferences regarding optimization decisions and the like. For example, ML component 508 can employ a probabilistic-based or statistical-based approach in connection with choosing between known voice files and unknown voice files associated with a network of devices, whether the speech patterns of a particular voice file indicates urgency, etc. The inferences can be based in part upon explicit training of classifier(s) (not shown) before employing the system 500, or implicit training based at least upon a device user's previous input, choices, and the like during use of the device. Data or policies used in optimizations can be collected from specific users or from a community of users and their devices, provided by one or more device service providers, for instance.

ML component 508 can also employ one of numerous methodologies for learning from data and then drawing inferences from the models so constructed. For example, ML component 508 can utilize Gaussian Process (GP) Classification and related models. Additionally and/or alternatively, ML component 508 can utilize more general probabilistic graphical models such as Bayesian networks. A Bayesian network can be created, for example, by structure search using a Bayesian model score or approximation, linear classifiers such as support vector machines (SVMs), non-linear classifiers such as methods referred to as neural network methodologies, fuzzy logic methodologies, and/or other approaches that perform data fusion.

Methodologies employed by ML component 508 can also include mechanisms for the capture of logical relationships such as theorem provers or more heuristic rule-based expert systems. Inferences derived from such learned or manually constructed models can be employed in optimization techniques, such as linear and non-linear programming, that seek to maximize some objective function.

In accordance with one aspect of the claimed subject matter, ML component 508 can utilize a GP classification to directly model a predictive conditional distribution p(t|x) to facilitate the computation of actual conditional probabilities without requiring calibrations or post processing. To that end, the posterior distribution over the set of all possible classifiers given a training set can be expressed as

$$p ( w \vert {X}_{L} , {T}_{L} ) = p ( w ) {\prod }_{i ∈ L} p ( {t}_{i} \vert w , {x}_{i} ) ,$$

where p(w) corresponds to a prior distribution over classifiers and can be selected to prefer parameters w that have a small norm. In one example, a prior distribution can be a spherical Gaussian distribution on weights w˜N(0, I). This prior distribution can impose a smoothness constraint and act as a regularizer to give higher probability to labels that respect similarities between data points. The likelihood terms p(tᵢ|w,xᵢ) can incorporate the information from labeled data. Alternatively, other forms of distributions can be selected. For example, the probit likelihood p(t|w,x)=Ψ(t·w^{T}x) can be used, where Ψ(·) denotes the cumulative density function of the standard normal distribution. The posterior can consist of parameters that have small norms and that are consistent with the training data.

Computation of the posterior p(w|X,T) can then be accomplished by ML component 508 using non-trivial and approximate inference techniques such as Assumed Density Filtering (ADF) or Expectation Propagation (EP). ADF can be used to approximate the posterior p(w|X_{L},T_{L}) as a Gaussian distribution, e.g., p(w|X_{L},T_{L})=N( w̅,Σ_{w}). Similarly, EP can be performed as a generalization of ADF, where an approximation obtained from ADF is refined using an iterative message passing scheme.

Given an approximate posterior p(w|X,T) [symbol] N( w̅,Σ_{w}), the mean w̅ of the distribution (or the Bayes point) can classify a test point according to sign( w̅^{T}x). In one example, the above can be generalized to the non-linear case using the kernel trick by first projecting the data into a higher dimensional space to make it separable.

A predictive distribution can then be obtained by using a GP classification framework p(sign(f(x))|x) as follows:

$$p ( sign ( f ( x ) ) = 1 \vert x ) = Ψ ( \frac{{\overline{w}}^{T} x}{\sqrt{{x}^{T} {\sum }_{w} x + 1}} ) \qquad ( 1 )$$

Unlike other classifiers, the GP classification can model the predictive conditional distribution p(t|x) to facilitate the computation of the actual conditional probabilities without requiring calibration or post-processing. This predictive distribution in the selective-supervision framework can compute expected risks and to quantify the value of individuals.

In one example, the underlying classifier utilized by the ML component 508 can be based on GP. In another example, GP can be extended to facilitate semi-supervised learning. The GP classification core can include a kernel matrix K, where entry Kᵢⱼ can encode the similarity between the i^{jth} and the j^{th} data points. The inverse of the transformed Laplacian, r(Δ)=Δ+σI where Δ=D−K, can then be used in place of K. As used in the Laplacian, D is the diagonal matrix having diagonal elements Dᵢᵢ=ΣⱼKᵢⱼ. A scalar σ>0 can be added to remove the zero eigen value from the spectrum of r(Δ). The inverse of the transformed Laplacian can compute the similarity over a manifold. This can allow the unlabeled data points to help in classification by populating the manifold and can use the similarity over the manifold to guide the decision boundary. The extension of GP classification to handle semi-supervised learning can be related to the graph-based methods for semi-supervised learning. The rest of the active learning framework can be used as it is on top of this semi-supervised GP classification framework.

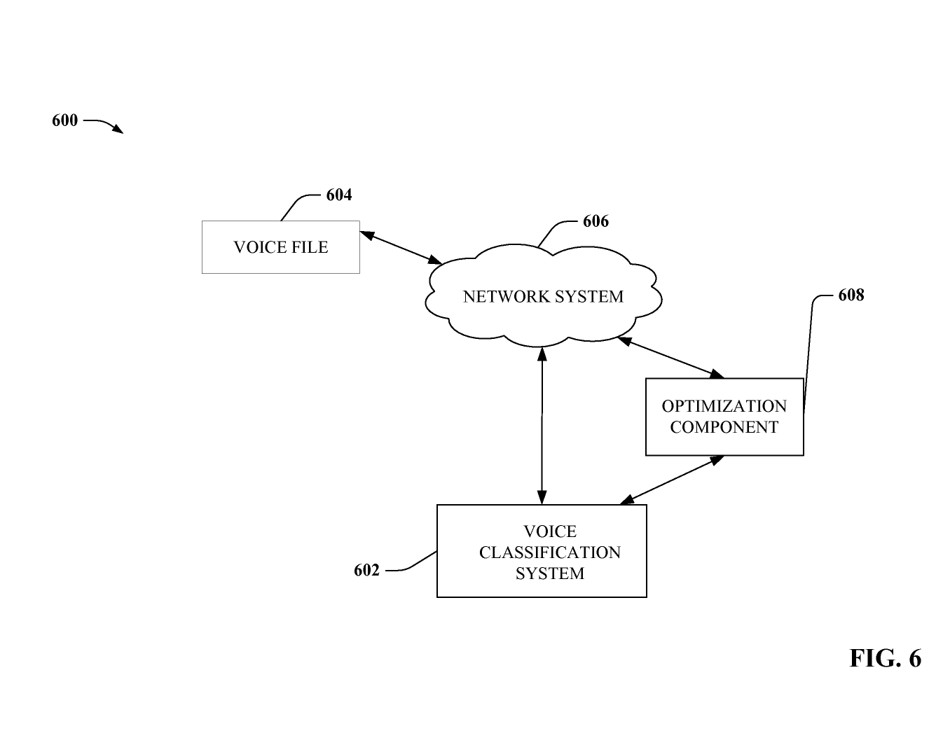

FIG. 6 depicts an example system 600 that can optimize system variables used by a distributed processing system in accordance with additional aspects of the claimed subject matter. In one example, system 600 can include a voice classification system 602, which can receive and classify voice files 604 assigned by strategic agents among network 606 devices as described herein. Specifically, such classification can include identifying a voice file 604, grouping a voice file 604, and/or labeling a voice file 604.

An optimization component 608 can provide real-time closed loop feedback of the state of a network system 606 and networked devices. More specifically, optimization component 608 can monitor the frequency of a particular voice file 604 in network system 606 and receive and compile a list of voice files 604, the identity of the voice files 604, and certain characteristics of the speech patterns of the voice files 604. Voice files 604 can be forwarded to voice classification system 602 to facilitate an accurate identification of the voice file 604 and the processing times utilized to calculate such classification. Speech patterns of voice files 604, which can dynamically change according the urgency or excitement of the caller, can also be provided to a user to a machine learning component (e.g., ML component 508) to facilitate accurate representation of a contemporaneous state of the system 600. Accurate representation can be important to assist an agent in determining a device that meets selfish desires of a user. In addition, knowledge of a concurrent state of a system can assist a voice classification system 602 in adjusting frequent voice file change. In the manner described, system 600 can optimize identifying a voice file as well as classifying the voice files into groups 602 by providing steady state feedback of a current state of a distributed network and corresponding devices.

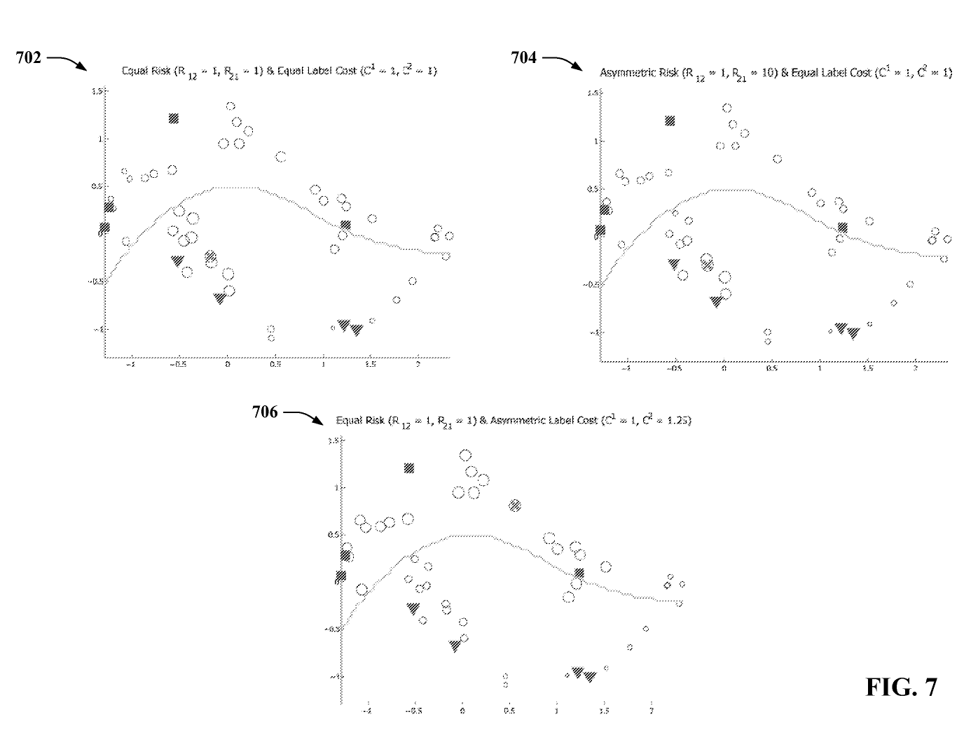

Referring now to FIG. 7, example value of information (VOI) data for a decision-theoretic framework in active learning in accord with aspects of the subject disclosure is illustrated. Said VOI data illustrates an example of a decision-theoretic framework in active learning, where the costs and risks in real-world currencies are considered and computations of expected value of information are employed to balance the cost of misdiagnosis with the costs of providing labels.

In one example, a linear classifier parameterized by w can classify a test point x according to sign(f(x)), where f(x)=w^{T}x. Given a set of training data points X_{L}={x₁, . . . , xₙ} with class labels T_{L}={t₁, . . . , tₙ}, where tᵢε{1,−1}, the goal of a learning algorithm can be to learn the parameters w. These preferences can be expressed in terms of real-world measures of cost such as a monetary value and can help with seeking to minimize the expected cost for the use of a classifier over time. Additionally, the cost of tagging cases for training can vary for cases in different classes or with other problem-specific variables.

In another example, a value of acquiring labels of different points can be quantified and computations of the value can be used as guiding principles in active learning. Knowing the label of one or more currently unlabeled points can reduce the total risk in the classification task. In addition, labels can be acquired at a price. The difference in the reduction in the total expected cost of the use of the classifier, the risk, and the cost of acquiring a new label can be the expected value of information for learning that label. The real-world cost associated with the usage of a classifier can be a function of the number of times that a classifier will be used in the real world so that a probability distribution over usage can be considered in the computation of expected cost.

In one example, system learning can be accomplished using two-class discrimination problems. Additionally, system learning can be conducted under an assumption that only one data point is to be labeled at a time. Accordingly, a risk matrix R=[Rᵢⱼ]εIR^{2×2}, can be defined, where Rᵢⱼ denotes the cost or risk associated with incorrectly classifying a data point belonging to class i as j. In one example, the index 2 can be used to denote the class −1. It can also be assumed that the diagonal elements of R are zero, specifying that correct classification incurs no cost. In another example, given the labeled set X_{L} with labels T_{L}, training of a classifier f(x) and computation of total risk on labeled data points can be accomplished by using the following equation:

$${J}_{L} = {\sum }_{i ∈ {L}_{+}} {R}_{12} ( 1 - {p}_{i} ) + {\sum }_{i ∈ {L}_{-}} {R}_{21} {p}_{i} \qquad ( 2 )$$

where pᵢ denotes the probability that the point xi is classified as class +1, i.e., pᵢ=p(sign(f(xᵢ))=1|xᵢ), and L₊ and L₋ respectively represent the indices of positively and negatively labeled points. The pᵢ can be the predictive distribution and depending upon the classification technique can be available in some instances. Predictive distributions can be available for GP classification and other probabilistic classifiers, including probabilistic mappings of outputs of SVMs.

In addition to labeled cases, a set of unlabeled data points Xᵢⱼ={xₙ₊₁, . . . , xₙ₊ₘ}, can also be classified. The total risk associated with the unlabeled data points can be expressed as follows:

$${J}_{U} = {\sum }_{i ∈ U} {R}_{12} ( 1 - {p}_{i} ) \cdot {p}_{i}^{*} + {R}_{21} {p}_{i} \cdot ( 1 - {p}_{i}^{*} ) , \qquad ( 3 )$$

where p*ᵢ=p(tᵢ=1|xᵢ) is the true conditional density of the class label given the data point. An exact computation of the expression may not be available because no true conditional may exist. Instead, an approximation p*ᵢ of Pᵢ can be used and a total risk on the unlabeled data points can be determined as follows:

$${J}_{U} \approx {\sum }_{i ∈ U} ( {R}_{12} + {R}_{21} ) ( 1 - {p}_{i} ) \cdot {p}_{i} \qquad ( 4 )$$

In one example, Cᵢ can denote the cost of knowing the class label of xᵢ. The cost of Cᵢ and the risks R₁₂ and R₂₁ can then be measured with the same currency. In another aspect, different currencies can be transformed into a single utility by using appropriate real-world conversions.

Given the risks (J_{L} and J_{U}), the expected misclassification cost per joint can be approximated as

$$\overline{J} = \frac{{J}_{L} + {J}_{U}}{n + m} .$$

Assuming a closed world, where the system only encounters the n+m points in X_{L}∪X_{U}, the expected cost can be the sum of the total risk:

Jₐₗₗ=(n+m) J̅ (5)

Alternatively given the closed system with the set of unlabeled and the labeled data points, the risk can also be approximated as:

$${J}_{all} = {\sum }_{i ∈ L ⋃ U} {1}_{[ f ( {x}_{i} ) = 2 ]} \cdot {R}_{12} {p}_{i} + {1}_{[ f ( {x}_{i} ) = 1 ]} \cdot {R}_{21} ( 1 - {p}_{i} ) \qquad ( 6 )$$

Here, 1_{[ ]} denotes the indicator function. Both, expressions of risk given in equation 5 and 6 use the fact that the predictive distribution pᵢ, the probability that xᵢ belongs to class 1, is available. The following discussion is applicable irrespective any of the expressions for the total risk.

Given the expression for the total risk, the cost of obtaining the labels, which can be expressed as follows:

$$U = {J}_{all} + {\sum }_{i ∈ L} {C}_{i} \qquad ( 7 )$$

Upon querying the new point, a reduction in the total risk may occur. However, a cost can be also incurred when a label is queried and computing the difference in these quantities triages the selection of cases to label. In one example, the VOI of an unlabeled point xⱼ can be defined as the difference in the reduction in the total risk and the cost of obtaining the label as follows:

VOI(xⱼ)=U−U^{j}=(Jₐₗₗ−Jₐₗₗ^{j})−Cⱼ, (8)

where U^{j} and Jₐₗₗ^{j} denote the total expected cost and the total misclassification risk respectively if xⱼ is considered as labeled. The VOI can quantify the gain in utilities in terms of the real-world currency that can be obtained by querying a point. Choosing next for labeling the point that has the highest value of information can result in minimization of the total cost U that consists of the total risk in misclassification as well as the labeling cost.

The terms Jₐₗₗ^{j} for the j^{th} data point can be approximated with an expectation of the empirical risk as: jₐₗₗ^{j}≈pⱼJ^{j,+}+J^{j,-}(1−pⱼ), where J^{j,+} and J^{j,-} denote the total risks when xⱼ is labeled as class 1 and class −1 respectively.

In one example, the risk J^{j,+} can be calculated by computing p^{j,+}. The variable p^{j,+} is defined as the resulting posterior probability upon adding xⱼ as a positively labeled example in the active set. The value of J^{j,+} and J^{j,-} can be determined using similar expressions to equations (5) and (6), supra. If the cost of labeling vary by class, the expectation of Cⱼ can be used. To that end, it can be advantageous to maximize VOI for labeling as follows:

$${j}_{sel} = arg {max}_{j ∈ U} VOI ( {x}_{j} ) \qquad ( 9 )$$

As mentioned earlier, ADF or EP can be used for approximate inference in GP classification. However, such a scheme for selecting unlabeled points can be computationally expensive. In one example, the computational complexity for EP is O(n³), where n is the size of the labeled training set. For example, to compute a value of information (VOI) for every unlabeled data point, which corresponds to a gain in utilities in terms of real-world currency that can be obtained by querying a point, it may be necessary to perform EP twice for every point under consideration. A faster alternative can be the use of ADF for approximating the new posterior over the classifier.

Specifically, to compute the new posterior p^{j,+}(w|X_{L∪j},{T_{L}∪+1}), the Gaussian projection of the old posterior can be multiplied by the likelihood term for the j^{th} data point. This can be expressed as p^{j,+}(w|X_{L∪j},{T_{L}∪+1})≈N( w̅^{j,+},Σ_{w}^{j,+}), where w̅^{j,+} and Σ_{w}^{j,+} are respectively the mean and the covariance of p(w|X_{L},T_{L})·Ψ(1·w^{T}xⱼ). It can be observed that this is equivalent to performing ADF starting with the old posterior p(w|X_{L},T_{L}) and incorporating the likelihood term Ψ(1·w^{T}xⱼ). Further, it can be observed that this technique does not necessarily require O(n³) operations to compute VOI for every unlabeled data point. Similar computations can be used to approximate p^{j,-}(w|X_{L∪j},{T_{L}∪−1}) .

In one example, a stopping criterion can be employed when VOI(xⱼ_{ₛₑₗ}) is less than zero because a condition can occur where knowing a single label does not reduce the total cost. The stopping criterion for an open-world situation can include the computation of gains in accuracy of the classifier over multiple uses, based on a probability distribution over expected cases and the lifespan of the system. In another example, a greedy policy can indicate stopping when there is a potential for further reduction of the over cost via querying a set of points.

With reference again to FIG. 7, graphs 702-706 illustrate the selection of unlabeled points to query based on the VOI criterion. The sample data consists of two half moons in a multidimensional space, where the top half belongs to class +1 and the bottom to the class −1. Pre-labeled cases are represented in graphs 702-706 as squares for class 1 and triangles for class −1. Graphs 702-706 correspond to different settings of risks (R₁₂ and R₂₁) and labeling costs. C¹ and C² can be assumed to be the costs for querying points that belong to class +1 and −1 respectively. Unlabeled points in graphs 702-706 are displayed as circles, where the radii correspond to the VOI of labeling these cases. The next case selected to be queried is marked with a cross. Graph 702 shows the VOI for all the unlabeled data points and the case selected for the next query when the risks and the cost of labelings are equal for both classes. For this situation, cases that are nearest to the decision boundary are associated with the highest VOI. Choosing cases that minimize the objective for overall cost corresponds to the selection of queries that would minimize the classification error; hence, the points at the decision boundary can be the ones that are the most informative.

Graph 704 illustrates a situation where it is far more expensive to misclassify a point belonging to class −1. Due to this asymmetry in risks, the points that are likely to belong to class −1, but that also lay close to the decision boundary, have the highest VOI. Graph 706 depicts a situation where obtaining a label for a point in class −1 is 1.25 times as expensive to obtain the label for a point belonging to class 1. The VOI is highest for those points that are more likely to belong to class 1 and that are close to the decision boundary. The sample data set illustrates how VOI can be used effectively to guide tagging supervision such that it minimizes both the operational and training costs of a classifier.

The closed system in the example above was assumed where both the set of the labeled and the unlabeled data are available beforehand and was not a transductive learning framework; the final classification boundary depends only on the labeled data. Both the labeled and the unlabeled data points can be used only to determine which cases to query. Once trained, the classifier can be applied to novel test points, beyond the original set of labeled and the unlabeled points.

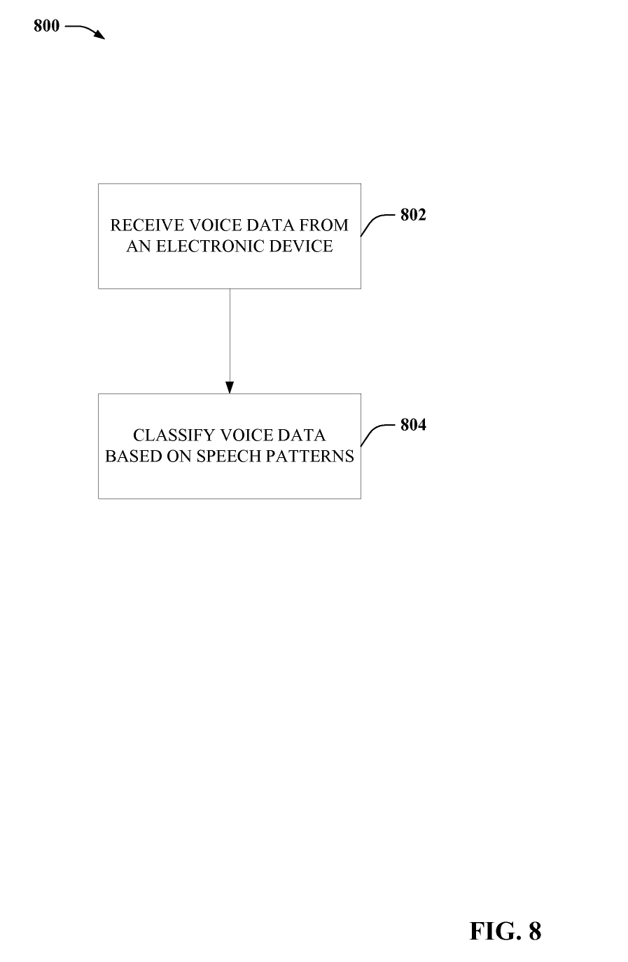

FIGS. 8-10 depict example methodologies according to innovative aspects of the subject disclosure. While, for purposes of simplicity of explanation, the methodologies shown herein, e.g., in the form of flow charts or flow diagrams, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

FIG. 8 is a flowchart of a method 800 of extracting features from voice file for the purpose of sorting the speech patterns according to an embodiment of the claimed subject matter. At 802, voice files are received from an electronic device that encompasses speech patterns from a recorded message, live call, or an electronic device. Such voice data can include a digital voice mail message, a real time caller on a telephone or a cell phone, a television broadcast, or a radio broadcast.

At 804, speech patterns of the voice input are used to classify the voice data. In one example, classification is performed using an accuracy parameter associated with each classification, where the accuracy parameter is based on recognition of the speech patterns and labeling the speech patterns. Furthermore, the classification of the voice data at 804 can utilize active learning through a machine learning component and various algorithms. In as such a manner, methodology 800 can produce an efficient classification system of voice mail, calls, and/or news or radio broadcasts. The classification can ease navigation to find messages of interest to the user.

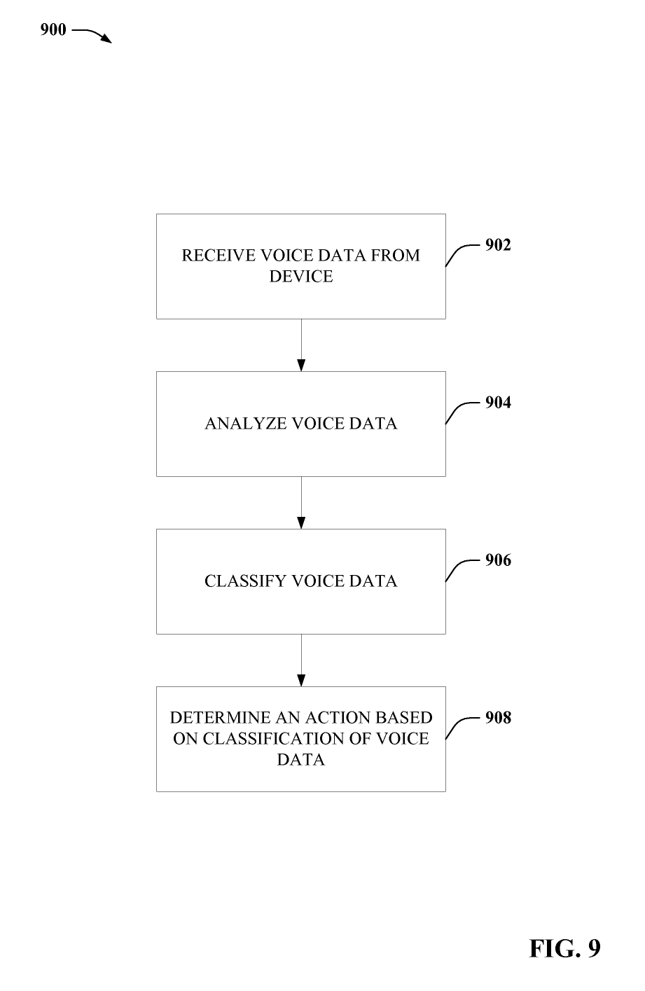

FIG. 9 illustrates an example methodology 900 of labeling classification of speech patterns from voice files in accord with aspects disclosed herein. At 902, a voice file can be received by an electronic device. A processing device can translate the voice file into computer data indicating unique speech patterns. At 904, speech patterns from the voice file are extracted from the computer generated data. Certain features of the speech pattern are considered and grouped. Groups can include metadata, prosodic features and/or key words. At 906, voice files are classified based on key features, assembled into groups and labeled to indicate messages of interest. At 908, an action is determined based on the classification. In one example, the action determined at 908 can include forwarding information to a graphical user interface. In another example, the action can include proceeding to voice messaging or transferring the live call to a messaging agent.

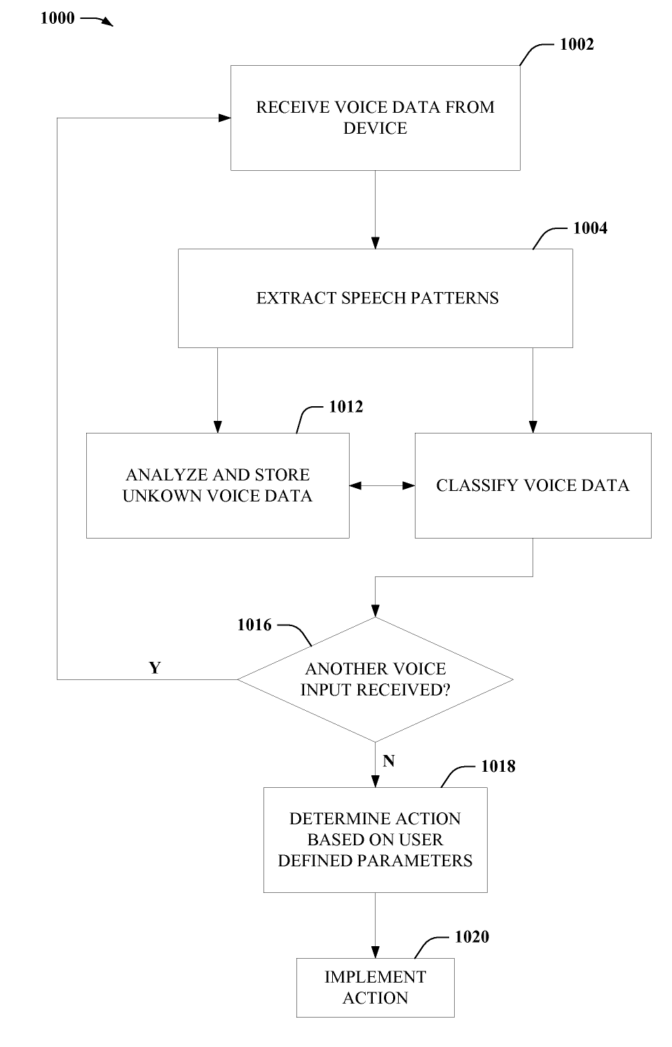

FIG. 10 is a flowchart illustrating a process 1000 for determining call labels for speech patterns from voice inputs in accordance with aspects disclosed herein. At 1002, a voice file, such as a voice message, real time call, and/or a news/radio broadcast, is received. At 1004, features of speech patterns are extracted from the voice data. These features can include, for example, metadata, prosodic features, and/or key words. In one example, metadata extracted at 1004 can include the date and time of a call, the size of a voicemail message in bytes, the length of a voicemail message in seconds, whether a call is made from an external caller or a caller from the users organization, and/or other appropriate features. In another example, prosodic features extracted at 1004 can include syllable rate, pause structure, and pitch dynamics. Pitch dynamics can be extracted at 1004, for example, by employing a pitch tracker and then extracting the prosodic features. Prosodic features extracted at 1004 can also include, for example, duration of silence, duration of voiced segment, length of productive segment, and change in pitch during a productive segment. Further, key words extracted at 1004 can be changed according to a preference of the user. For example, the user may define key words as urgent, emergency, the company name, and another other word that would be of interest when searching through the call labels. Each of these features enable to system to calculate the probability that the speaker is known.

At 1012, classification of voice files that have not been stored, can be stored and classified. At 1014, if the voice file has been stored and is recognized by the system, key features can be classified. A determination of urgency can also be made, and a call label can be attached to the voice file. At 1016, it is determined whether another voice file is present. If another voice file is present, the process 1000 returns to 1002 for the new voice file. If another voice file is not present, an action based on the voice file type and the call label can be determined at 1018 and implemented at 1020.

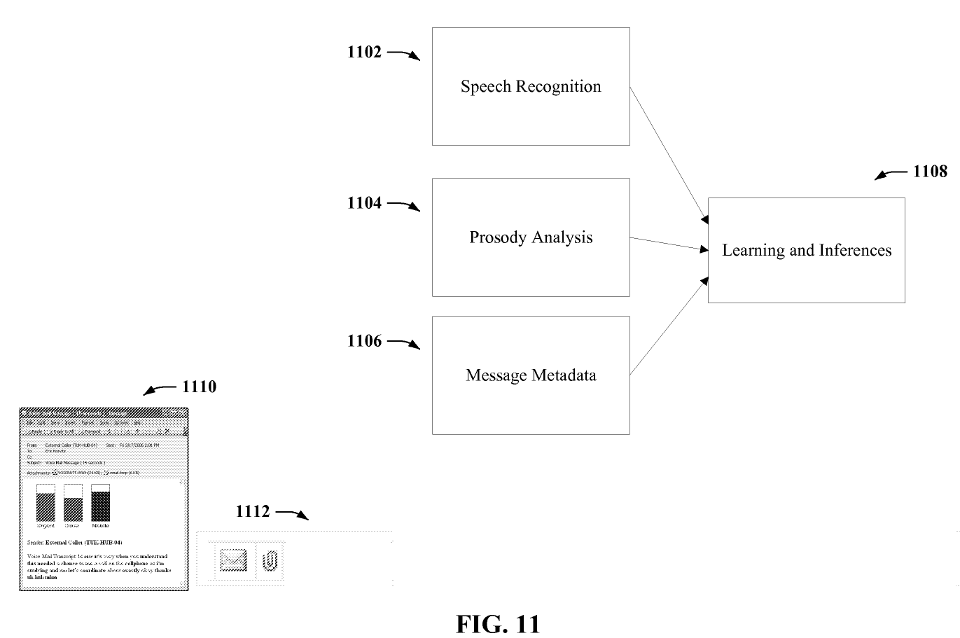

FIG. 11 illustrates an example of automatic call classification and prioritization displayed on a graphical user interface. At 1102, 1104 and 1106, key features are extracted from a voice input. Specifically, at 1102, user defined key words can be recognized. At 1104, the voice input is analyzed for prosodic features. Prosodic features analyzed can include pitch of the voice input, pauses between words and/or emphasis on certain words. At 1106, metadata associated with the call can be acknowledged. At 1108, the system can learn to recognize and classify the key features and make inferences based on the key features. At 1110, the inferences made based on the key features can be displayed on a graphical user interface. For example, at 1112, a graphical user interface can display a message if there is an urgent call.

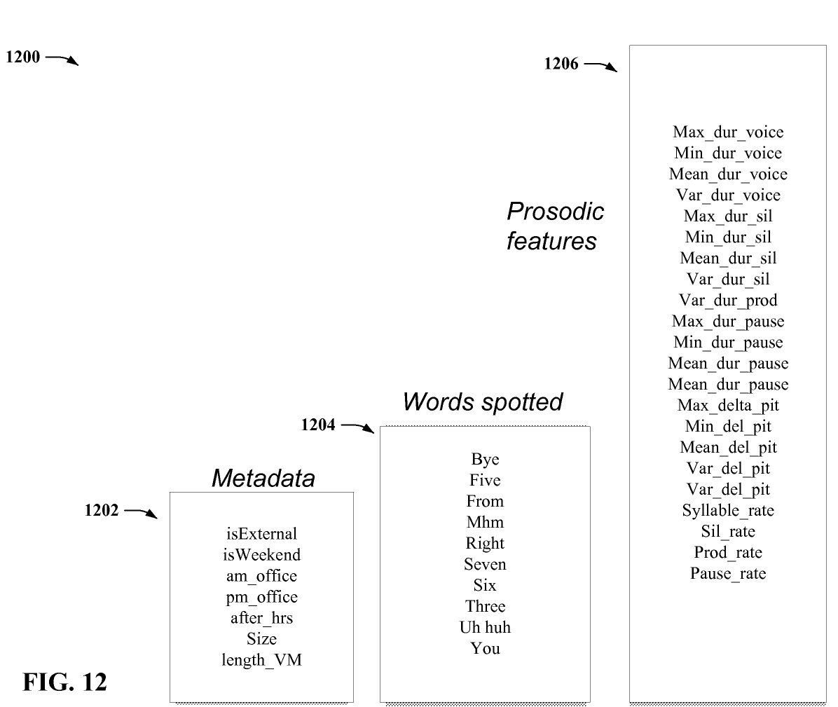

FIG. 12 illustrates an example of key features extracted from a voice input. At 1202, metadata associated with a call can be retrieved. For example, the date and time of the call, whether the call was during office hours, the length of the voice mail, and/or if the call originated from an external phone can all be determined. At 1204, key words that can indicate messages of interest can be recognized. For example, in 1204, if a caller uses the words “bye”, “five”, and/or “from” the call can be tagged as a message of interest. At 1206, prosodic features of the callers' speech patterns can be analyzed. Pitch, duration of pauses, and/or syllable rates can all be used to determine the level of urgency related to the call.

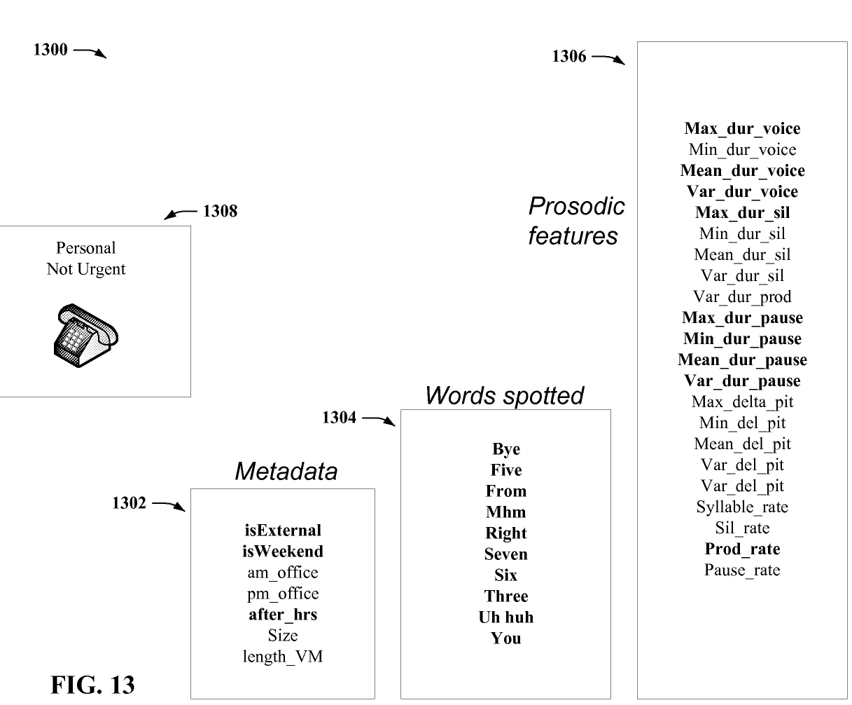

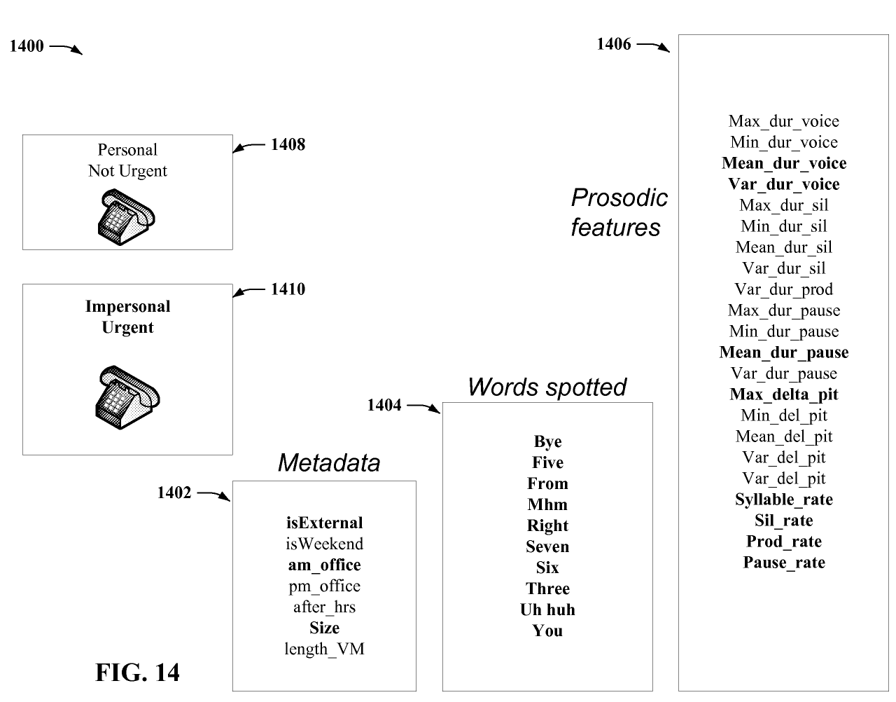

FIG. 13 and FIG. 14 illustrate examples of the classifying calls based on key features related to the calls'. The difference in the key feature (i.e. metadata, words spotted and prosodic features) of the calls indicates different classifications for the calls. For example, FIG. 13 illustrates an example of key features extracted from a personal, non-urgent call. The classification of personal, non-urgent is based on a combination of the calls metadata, words spotted and prosodic features. Using the key features, the system can infer the call is personal, non-urgent. Similarly, FIG. 14 illustrates an example of key features extracted from an impersonal urgent call. Using the key feature, the system can infer the call is an impersonal urgent call.

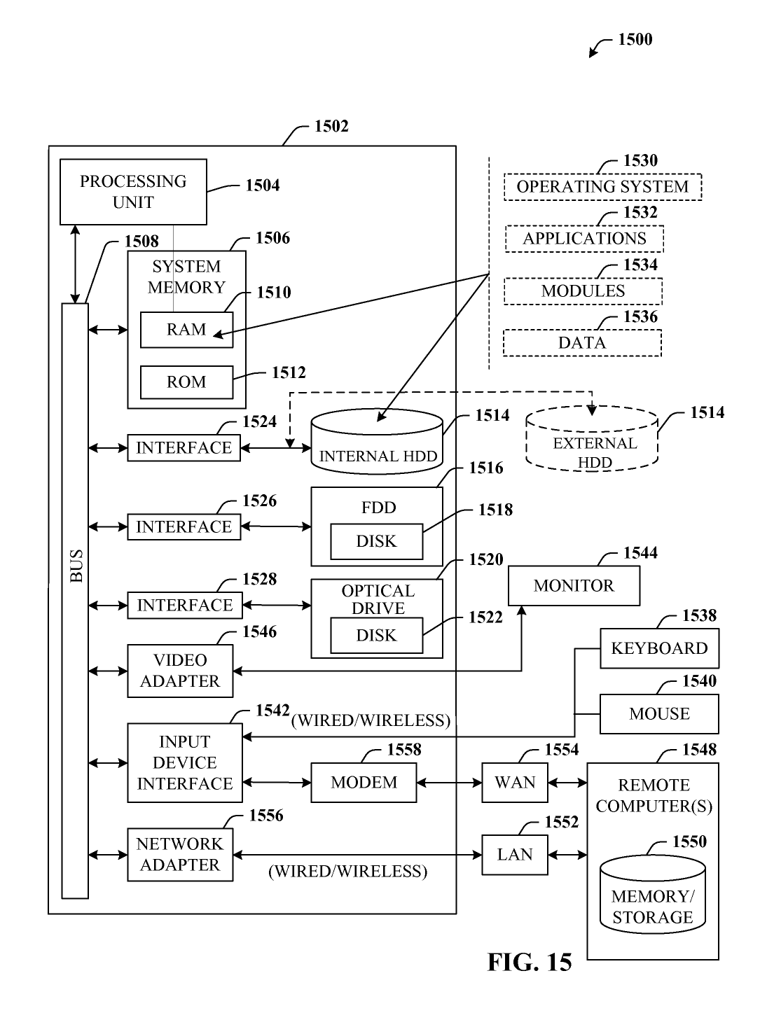

In order to provide additional context for various aspects of the subject specification, FIG. 15 and the following discussion are intended to provide a brief, general description of a suitable computing environment 1500 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 15, the example environment 1500 for implementing various aspects of the specification includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures may also be employed as the processing unit 1504.

The system bus 1508 can be any of several types of bus structure that may further interconnect to a memory bus (with or without a memory controller), a peripheral bus, and a local bus using any of a variety of commercially available bus architectures. The system memory 1506 includes read-only memory (ROM) 1510 and random access memory (RAM) 1512. A basic input/output system (BIOS) is stored in a non-volatile memory 1510 such as ROM, EPROM, EEPROM, which BIOS contains the basic routines that help to transfer information between elements within the computer 1502, such as during start-up. The RAM 1512 can also include a high-speed RAM such as static RAM for caching data.

The computer 1502 further includes an internal hard disk drive (HDD) 1514 (e.g., EIDE, SATA), which internal hard disk drive 1514 may also be configured for external use in a suitable chassis (not shown), a magnetic floppy disk drive (FDD) 1516, (e.g., to read from or write to a removable diskette 1518) and an optical disk drive 1520, (e.g., reading a CD-ROM disk 1522 or, to read from or write to other high capacity optical media such as the DVD). The hard disk drive 1514, magnetic disk drive 1516 and optical disk drive 1520 can be connected to the system bus 1508 by a hard disk drive interface 1524, a magnetic disk drive interface 1526 and an optical drive interface 1528, respectively. The interface 1524 for external drive implementations includes at least one or both of Universal Serial Bus (USB) and IEEE-1394 interface technologies. Other external drive connection technologies are within contemplation of the subject specification.

The drives and their associated computer-readable media provide nonvolatile storage of data, data structures, computer-executable instructions, and so forth. For the computer 1502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. It is appreciated that the specification can be implemented with various commercially available operating systems or combinations of operating systems.

A user can enter commands and information into the computer 1502 through one or more wired/wireless input devices, e.g., a keyboard 1538 and a pointing device, such as a mouse 1540. Other input devices (not shown) may include a microphone, an IR remote control, a joystick, a game pad, a stylus pen, touch screen, or the like. These and other input devices are often connected to the processing unit 1504 through an input device interface 1542 that is coupled to the system bus 1508, but can be connected by other interfaces, such as a parallel port, an IEEE-1394 serial port, a game port, a USB port, an IR interface, etc.

A monitor 1544 or other type of display device is also connected to the system bus 1508 via an interface, such as a video adapter 1546. In addition to the monitor 1544, a computer typically includes other peripheral output devices (not shown), such as speakers, printers, etc.

The computer 1502 may operate in a networked environment using logical connections via wired and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wired/wireless connectivity to a local area network (LAN) 1552 and/or larger networks, e.g., a wide area network (WAN) 1554. Such LAN and WAN networking environments are commonplace in offices and companies, and facilitate enterprise-wide computer networks, such as intranets, all of which may connect to a global communications network, e.g., the Internet.

When used in a LAN networking environment, the computer 1502 is connected to the local network 1552 through a wired and/or wireless communication network interface or adapter 1556. The adapter 1556 may facilitate wired or wireless communication to the LAN 1552, which may also include a wireless access point disposed thereon for communicating with the wireless adapter 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wired or wireless device, is connected to the system bus 1508 via the serial port interface 1542. In a networked environment, program modules depicted relative to the computer 1502, or portions thereof, can be stored in the remote memory/storage device 1550. It will be appreciated that the network connections shown are example and other means of establishing a communications link between the computers can be used.

The computer 1502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 11BaseT wired Ethernet networks used in many offices.

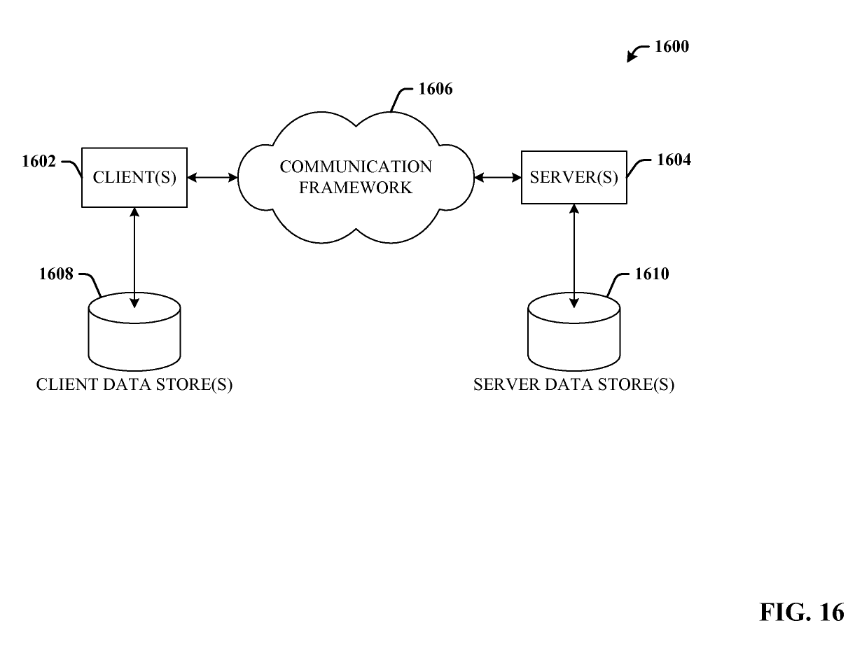

Referring now to FIG. 16, there is illustrated a schematic block diagram of a computing environment 1600 in accordance with the subject specification. The system 1600 includes one or more client(s) 1602. The client(s) 1602 can be hardware and/or software (e.g., threads, processes, computing devices). The client(s) 1602 can house cookie(s) and/or associated contextual information by employing the specification, for example.

The system 1600 also includes one or more server(s) 1604. The server(s) 1604 can also be hardware and/or software (e.g., threads, processes, computing devices). The servers 1604 can house threads to perform transformations by employing the specification, for example. One possible communication between a client 1602 and a server 1604 can be in the form of a data packet adapted to be transmitted between two or more computer processes. The data packet may include a cookie and/or associated contextual information, for example. The system 1600 includes a communication framework 1606 (e.g., a global communication network such as the Internet) that can be employed to facilitate communications between the client(s) 1602 and the server(s) 1604.

Communications can be facilitated via a wired (including optical fiber) and/or wireless technology. The client(s) 1602 are operatively connected to one or more client data store(s) 1608 that can be employed to store information local to the client(s) 1602 (e.g., cookie(s) and/or associated contextual information). Similarly, the server(s) 1604 are operatively connected to one or more server data store(s) 1610 that can be employed to store information local to the servers 1604.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that determines call features, comprising:
a voice analysis component that classifies a voice file based on at least one of metadata, prosodic features, and key words; and
a decision component that implements an action based on the classification of the voice file.

2. The system of claim 1, further comprising a classifier component that identifies the voice file based on one or more of the source of the voice file and a level of urgency associated with the voice file.

3. The system of claim 2, wherein the call classifier component applies a statistical classifier to classify the voice file.

4. The system of claim 1, further comprising a processor component that translates the voice file into computerized data.

5. The system of claim 1, further comprising a classification component that classifies the voice file into one of a plurality of groups.

6. The system of claim 1, further comprising a call label component that attaches a call label to the voice file.

7. The system of claim 6, further comprising a graphical user interface that displays the call labels.

8. The system of claim 1, further comprising an action determination component that determines the action based at least in part on an identity of the voice file.

9. The system of claim 7, wherein the action determination component determines an action based at least in part on a level of urgency associated with the voice file.

10. The system of claim 1, further comprising a machine learning component that creates a trained model of the voice file based on user preference.

11. The system of claim 1, further comprising a storage component that stores data associated with the voice file.

12. A method of building and using classifiers for voice files, based on the extraction of key evidential features comprising:
analyzing the voice file for predetermined voice input features, the predetermined voice input features including metadata, words or phrases, and prosodic features;
classifying the voice file into one of a plurality of categories; and
determining an action to be taken in response to the voice file.

13. The method of claim 12, wherein the classifying the voice input includes:
identifying the source of the voice input, and
identifying a level of urgency associated with the voice input.

14. The method of claim 12, further comprising implementing machine learning to recognize speech patterns of frequent voice inputs and stores a trained model corresponding to a frequent voice file.

15. The method of claim 12, wherein the (act) includes scrutinizing the voice file and extracting user defined voice file features.

16. The method of claim 12, further comprising labeling the voice file with a classification for the voice file.

17. The method of claim 16, further comprising labeling the voice file with a classification, the classification comprising of one or more of unsolicited, business, personal, urgent, nonurgent, close friend/family, not close friend/family, mobile, and nonmobile.

18. The method of claim 17, further comprising reporting categories to a user interface system based on user preference and probabilities inferred about a set of categories of interest.

19. The method of claim 12, wherein the determining an action includes determining the action based at least in part on a level of urgency in the voice file.

20. A system that determines features of a voice file, comprising:
means for analyzing the voice file for voice input features;
means for recognizing speech patterns using machine learning;
means for classifying voice input into categories; and
means for determining an action in response to voice file.
